(19) United States
(12) Patent Application Publication
(10) Pub. No.: US 2015/0042678 A1
(43) Pub. Date: Feb. 12, 2015

(54) METHOD FOR VISUALLY AUGMENTING A REAL OBJECT WITH A COMPUTER-GENERATED IMAGE

(71) Applicant: Metaio GmbH, Munich (DE)

(72) Inventors: Thomas Alt, Pullach im Isartal (DE); Peter Meier, Munich (DE)

(73) Assignee: Metaio GmbH, Munich (DE)

(21) Appl. No.: 13/963,736

(22) Filed: Aug. 9, 2013

(51) Int. Cl. G09G 5/377

(52) U.S. Cl. CPC G09G 5/377
USPC 345/633

(57) ABSTRACT

A method and system for visually augmenting a real object with a computer-generated image that includes sending a virtual model in a client-server architecture from a client computer to a server via a computer network, receiving the virtual model at the server, instructing a 3D printer to print at least a part of the real object according to the virtual model, generating an object detection and tracking configuration configured to identify at least a part of the real object, receiving an image captured by a camera representing at least part of an environment in which the real object is placed, determining a pose of the camera with respect to the real object, and overlaying at least part of a computer-generated image with at least part of the real object.

### BACKGROUND OF THE INVENTION

1. Technical Field

The present disclosure is related to a method for visually augmenting a real object with a computer-generated image.

2. Background Information

It is known in the art to create or print real objects using a so-called 3D printer. Commonly known 3D printers that could perform 3D printing processes to print a real object from an input of a virtual model are presently available to consumers. As known in the art, additive manufacturing based 3D printing is a promising and emerging technology to print or create a 3D or 2D real (i.e. physical and tangible) object of any shape. As known in the art, additive manufacturing or 3D printing is a process of making a three-dimensional solid object of virtually any shape from a virtual model. 3D printing is achieved using an additive process, where successive layers of material are laid down in different shapes. For example, to perform a print, the 3D printer reads the design from a file and lays down successive layers of liquid, powder, paper or sheet material to build the model from a series of cross sections. These layers, which correspond to the virtual cross sections from the virtual model, are joined or automatically fused to create the final shape. The primary advantage of this technique is its ability to create almost any three-dimensional shape or geometric feature.

The virtual model represents the geometrical shape of the real object to be built or printed. The virtual model could be any digital model or data that describes geometrical shape property, such as a computer-aided design (CAD) model or an animation model. The printed real object is tangible. The object or the part of the object may have a void or hollow in it, such as has a vase. The object or the part of the object may be rigid or resilient, for instance.

3D printers are commonly based on additive manufacturing that creates successive layers in order to fabricate 3D real objects. Each lay could be created according to a horizontal cross-section of a model of a real object to be printed. 3D printers are typically used to create new physical objects that do not exist before.

In US 2011/0087350 A1, there is provided a method and system enabling the transform of possibly corrupted and inconsistent virtual models into valid printable virtual models to be used for 3D printing devices.

U.S. Pat. No. 8,243,334 A generates a 3D virtual model for the use in 3D printing by automatically delineating object of interest in images and selecting a 3D wire-frame model of an object if interest as the virtual model. The 3D wire-frame model may be automatically calculated from stereoscopic set of images.

U.S. Pat. No. 7,343,216 A proposes a method of assembling two real physical objects to have a final physical object. The method discloses an architectural site model facilitating repeated placement and removal of foliage to the model. The site model is constructed as an upper shell portion and a lower base portion, while the model foliage is attached to the shell portion. The upper shell portion of the site model is configured for removable attachment to the lower base portion. This method is not related to printing a physical object by a 3D printer.

### SUMMARY OF THE INVENTION

A 3D printer could print or make a real object from a virtual model of the object, as described above. Typically, surface texture of the printed object is depending on materials used by the printer for printing the object. Normally, the surface texture of the printed object cannot be physically changed or modified after the object is completely printed. Thus, there may be a need to visually change, e.g., a surface texture of a printed object without having to re-print another physical object from the same virtual model with different materials.

According to an aspect of the invention, there is provided a method for visually augmenting a real object with a computer-generated image comprising sending a virtual model in a client-server architecture from a client computer to a server via a computer network, receiving the virtual model at the server, instructing a 3D printer to print the real object or a part of the real object according to at least part of the virtual model received at the server, generating an object detection and tracking configuration configured to identify the real object or a part of the real object, receiving an image captured by a camera representing at least part of an environment in which the real object is placed, determining a pose of the camera with respect to the real object according to the object detection and tracking configuration and at least part of the image, and overlaying at least part of a computer-generated image with at least part of the real object according to the object detection and tracking configuration and the pose of the camera.

According to another aspect, there is provided a computer program product comprising software code sections which are configured to perform a method as described herein, particularly when loaded into the internal memory of a processing device.

Advantageously, the invention accounts for the fact that a 3D printer may not be available individually for each person or user at home or any other place having easy access to it. However, potential 3D printing service may be offered to individual persons, such as known for other services such as printing photographs. A user may use a client computer to send a 3D virtual model to a provider of a 3D printing service via a computer network. The provider of a 3D printing service may comprise or be a computer, particularly a server, which is located separately and remotely from the client computer and connected thereto through a computer network, such as the Internet. A 3D printer to which the 3D printing service, i.e. the server, has access prints a real object or a part of the real object according to at least part of the virtual model received by the provider of 3D printing service.

The printed real object may then be delivered to the user, for example by postal service or any other delivering method. Typically, a surface texture of the printed real object is depending on materials used by the 3D printer for printing, and is limited to certain visual effects, e.g. limited to few colors. Currently, it is difficult or even impossible to create a real object with a rich texture surface using a 3D printer. The printed real object could have a same or similar geometrical shape as the virtual model, while the surface of the printed real object may not have a same texture as the virtual model. Further, the user may want to visually change or augment the texture of at least part of the surface of the printed real object without a requirement of re-printing another real object from the same virtual model.

It is preferred to provide a method of visually augmenting a real object, at least part of which is printed by a 3D printer, by providing the visualization of overlaying a computer-generated image with the real object or a part of the real object based on an object recognition or object tracking configuration. For example, an identification code could be provided for the printed real object to recognize the real object and relate a texture data (e.g. computer-generated image) to the real object.

An aspect of the invention provides a method for visually augmenting a real object comprising the steps of sending a virtual model in a client-server architecture from a client computer to a server via a computer network, receiving the virtual model at the server, printing the real object or a part of the real object using a 3D printer according to at least part of the virtual model received at the server, generating an object detection and tracking configuration configured to identify the real object or a part of the real object, placing the real object into an environment for the real object to be viewed by a user, providing a camera capturing at least part of the environment and determining a pose of the camera with respect to the real object according to the object detection and tracking configuration, and overlaying at least part of a computer-generated image with at least part of the real object using a mobile device equipped with the camera according to the object detection and tracking configuration and the pose of the camera.

### BRIEF DESCRIPTION OF THE DRAWINGS

FIG. 1 shows a 3D printing system adapted for printing a real object and coupled to a client-server-architecture according to an embodiment of the invention.

FIG. 2 shows an exemplary mobile device, such as a smartphone, having a display for viewing a real object, e.g. an object which has been printed by a 3D printer according to FIG. 1, augmented with a computer-generated image.

FIG. 3 shows a flowchart of a method for visually augmenting a real object with a computer-generated image according to an embodiment of the invention with texturing an object printed by a 3D printer.

### DETAILED DESCRIPTION OF THE INVENTION

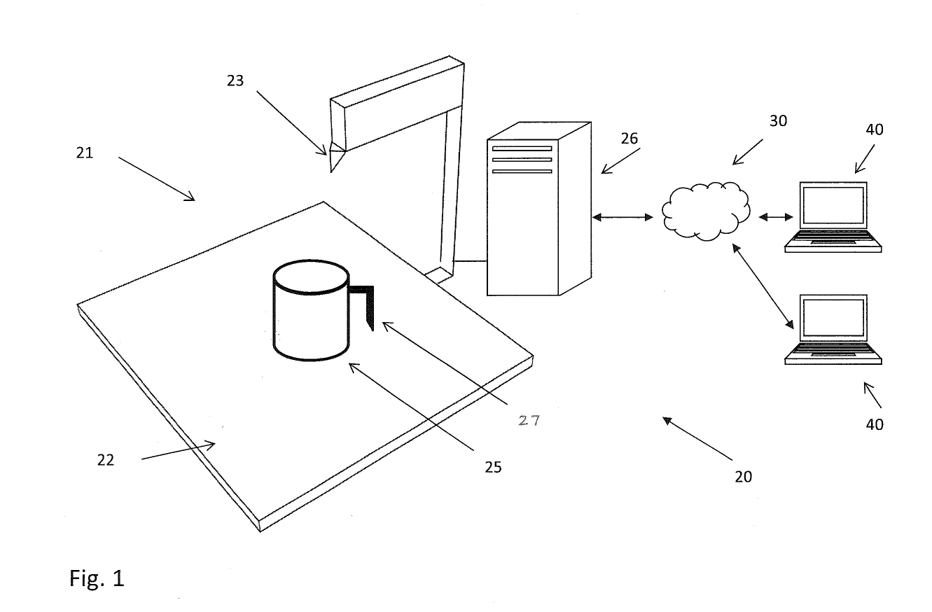

FIG. 1 shows a 3D printing system 20 adapted for printing a real object and coupled to a client-server-architecture according to an embodiment of the invention. In the left part of FIG. 1, it shows a 3D printer adapted for printing at least one real object 25. One embodiment of a 3D printer used for the purposes of the present invention may be a 3D printer 21 comprising a print head 23 and a printing platform 22. The 3D printer may move the print head 23 and/or the printing platform 22 to print an object 25, 27. Material and/or binding material is deposited from the print head on the printing platform or a printed part of an object until a complete object has been printed or made. Such process is commonly known by the person skilled in the art and shall not be described in more detail for reasons of brevity.

In terms of the present invention, the real object to be printed could be, in principle, any type of real object. The real object is physical and tangible. The real object or a part of the real object may have a void or hollow in it, such as has a vase. The physical object or the part of the physical object may be rigid or resilient. For example, a cup 25 with a handle 27 is an object to be printed by printer 21. The printing area of the 3D printer is an area where the print head 23 could reach to deposit material or a binding material.

FIG. 1 further shows an exemplary client-server architecture with which the 3D printing system 20 can communicate. The client-server architecture comprises one or more client computers 40 which can be coupled to a server 26 via a computer network 30, such as the internet or any other network connecting multiple computers. The client computer 40 may also be a mobile device having a processing unit, e.g. a smart phone or tablet computer. The server 26 has access to the 3D printing system 20 either directly through a wired or wireless connection or indirectly through, e.g., a data or file transfer of any kind known and common in the art. For example, a file generated at the server 26 used for printing an object with printer 21 may be transported (e.g. through an electrical or wireless connection, or physically through transporting a data carrier medium) to the 3D printing system 20 and loaded into an internal memory (not shown) of the printer 21. The virtual model used for printing the real object is received at the server 26 through the computer network 30. The virtual model may be created or selected at the client computer 40, e.g. by an appropriate application running on the client computer 40. The real object 25 or a part of the real object 25 is then printed by 3D printer 21 according to at least part of the virtual model as received at the server 26. That is, the virtual model received at the server is the basis for generating instructions for printing the object, particularly at the server 26. For this purpose, the server 26 either controls the printer 21 (with its print head 23 and printing platform 22) appropriately, e.g. by control commands sent to the printer 21, or any data or file generated by the server 26 and loaded into the memory of printer 21 comprises corresponding instructions (which may be compiled into printer format, or not, etc., depending on the particular application) which causes the printer 21 to print the object 25 or a part of the object 25.

A server, such as server 26, typically is a system (e.g., suitable computer hardware adapted with software) that responds to requests across a computer network to provide, or help to provide, a particular service. Servers can be or be run on a dedicated computer, which is also often referred to as “the server”, but multiple networked computers are also capable of forming or hosting servers. In many cases, a computer can provide several services and have several servers running. Servers operate within a client-server architecture, with servers including or being computer programs running to serve the requests of other programs, the clients. Thus, the server performs some task on behalf of clients. The clients typically connect to the server through a computer network. Servers often provide services across a network, either to private users inside a large organization or to public users via the internet. Typical servers are database server, print server, or some other kind of server. In principle, any computerized process that shares a resource to one or more client processes is a server. A server software can be run on any capable computer. It is the machine's role that places it in the category of server. In the present case, the server 26 performs some task on behalf of clients or provides services to clients related to 3D printing of objects based on a virtual model as described herein. What particular task or service and in what way this task or service is performed is not essential for the purposes of the invention.

A client computer typically is any processing device, such as a personal computer, tablet computer, mobile phone or other mobile device, having a processing unit and/or software that accesses a service made available by a server. In the present case, the client computer 40 accesses the server by way of a computer network 30. A client computer may include a computer program that, as part of its operation, relies on sending a request to another computer program, such as running on a server. The term “client” may also be applied to computers or devices that run the client software or users that use the client software. The client computer may run a software for creating or selecting a virtual model used for 3D printing. The virtual model may be manually defined in a 3D animation software, e.g. by manipulating one or more virtual models. The virtual model may also be pre-known and simply selected by the user.

A 3D printer could print or produce a real object, which is physical and tangible, from a virtual model of the object. Surface texture of the printed object is typically depending on materials used by the printer for printing. The surface texture of the printed object cannot be physically changed or modified after the object is completely printed. There may be a need to visually augment a surface texture of a printed object without re-printing another physical object from the same virtual model with different materials.

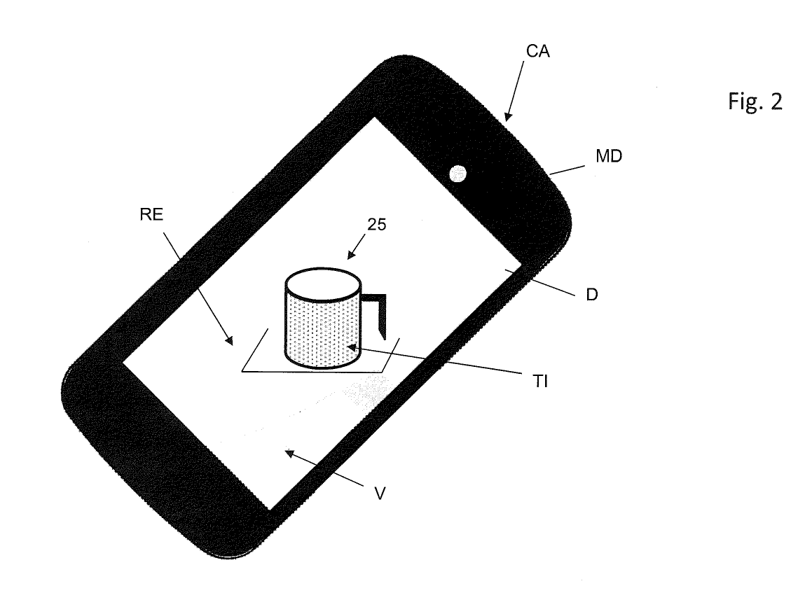

Referring again to FIG. 2, the object 25 printed by printer 21 is placed to be viewed by a user. Previously, for this purpose, it may be delivered from the printing location (where 3D printer 21 is located) to the user, e.g., by postal service, so that the user can place the printed object into an environment for intended use of the object (e.g., a kitchen environment in the present example of a cup 25). For viewing the object 25, a camera for capturing at least part of the object 25 is used, such as camera CA of mobile device MD or a camera provided with a head mounted display, as described further herein below.

The proposed invention can be generalized to be used with any camera or device providing images of real objects. It is not restricted to cameras providing color images in the so-called RGB (red-green-blue) format. It can also be applied to any other color format and also to monochrome images, for example to cameras providing images in gray scale format. The camera may further provide an image with depth data. The depth data does not need to be provided in the same resolution as the (color/grayscale) image. A camera providing an image with depth data is often called RGB-D camera. A useful RGB-D camera system could be a time of flight (TOF) camera system.

The at least one camera used for the purposes of the invention could also be a structured light scanning device, which could capture the depth and surface information of real objects in a real world, for example using projected light patterns and a camera system. The at least one image may be a color image in the RGB format or any other color format, or a grayscale image. The at least one image may also further have depth data.

The camera may be part of or may be associated with a mobile device. FIG. 2 shows an exemplary mobile device MD, such as a commonly known smartphone, having a display D for viewing a real environment. The mobile device has a processing unit (not shown) and appropriate software which are capable of augmenting a view of a real environment displayed on the display D with a computer-generated image, as described in more detail below. The mobile device MD may be equipped with a camera CA on its backside (not shown), as is known and commonly used in the art. Such systems and mobile devices are available in the art. Particularly, the mobile device MD may be the same device as the client computer 40.

In the example shown in FIG. 2, the user of mobile device MD views by means of the camera CA and display D showing the image captured by the camera a scene of a real environment RE comprising the cup 25 (e.g. placed on a plane of the real environment RE) after having been printed with the 3D printing system 20 according to FIG. 1. When viewed through display D, the cup 25 may be augmented with a computer-generated image, in the present example in the form of a texture information TI which is blended in into the view V such that it overlays the surface of the cup 25, thus augmenting the real cup 25 with a texture surface TI, as also described further herein below.

Augmented reality (AR) could be employed to visually augment the printed real object by providing an AR visualization of overlaying computer-generated virtual information (i.e. computer-generated image) with a view of the printed object or a part of the printed object. The virtual information can be any type of visually perceivable data such as texture, texts, drawings, videos, or their combination. The view of the printed object or the part of the printed object could be perceived as visual impressions by user's eyes and/or be acquired as an image by a camera.

The overlaid information of the computer-generated image and the real object can also be seen by users in a well-known optical see-through display having semi-transparent glasses. The user then sees through the semi-transparent glasses the real object augmented with the computer-generated image blended in in the glasses. The overlay of the computer-generated image and the real object can also be seen by the users in a video see-through display having a camera and a normal display device, such as is the case with mobile device MD of FIG. 2. The real object is captured by the camera (e.g., camera CA) and the overlay is shown in the display (e.g., display D) to the users. The overlay of the computer-generated image and the real object may also be realized by using a projector to project the computer computer-generated image onto the real object.

As described, the AR visualization could run on a mobile device equipped with a camera. The equipped camera could capture an image as the view of the at least part of the real object. The mobile device may further have semi-transparent glasses for the optical see-through, or a normal display for the video see-through, or a projector for projecting the computer computer-generated image. For reasons of brevity, the embodiments involving an optical see-through display and a projector, respectively, are not shown in detail herein, since they are well known in the art.

In order to overlay the computer-generated image with the real object at desired positions within the view captured by the eye or the camera, or project the computer-generated image onto desired surfaces of the real object using the projector, the camera of the mobile device could be used to determine a pose of the camera, or of the eye, or of the projector, with respect to the real object. It is particularly preferred to first determine a pose of the camera with respect to the real object based on an image captured by the camera.

When the view is captured as an image by the camera, the captured image may also be used to determine a camera pose of the image with respect to the real object, i.e. the pose of the view with respect to the real object. When the view is captured by the eye, in addition to determining the camera pose, it further needs a spatial relationship between the eyes and the camera or between an eye or head orientation detection system and the camera for determining the pose of the eye with respect to the real object.

For using the projector to project the computer-generated image onto the real object, in addition to determining the camera pose, a spatial relationship between the projector and the camera should be provided for determining a pose of the projector relative to the real object. In order to overlay computer-generated virtual information with an image of the printed object captured by a camera, it is also possible to directly compute the camera pose of the image with respect to the printed object based on a virtual model of the printed object and the image using computer vision methods. This does not require the printed object staying at its original place.

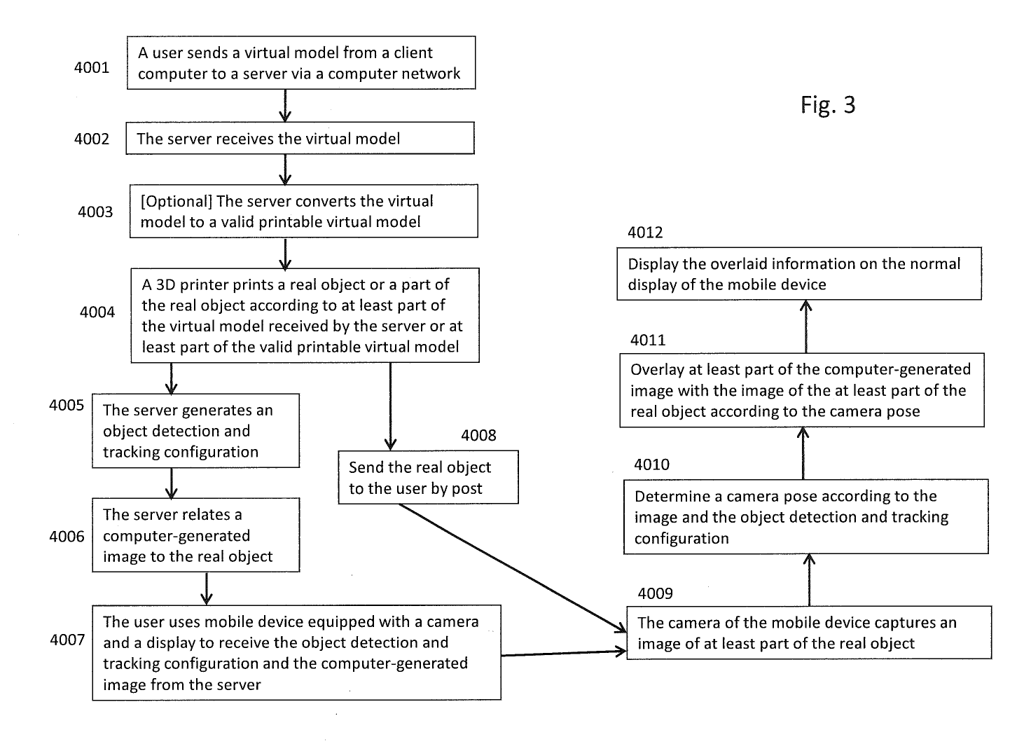

Further, reference is made to the flowchart of FIG. 3. It shows a flowchart of a method for visually augmenting a real object with a computer-generated image according to an embodiment of the invention, in the present example texturing an object printed by a 3D printer.

In step 4001, a user sends a virtual model from a client computer to a server via a computer network. Referring to FIG. 1, for example, user sends a virtual model from a client computer 40 to server 26 via a computer network 30. The computer network may be a telecommunications or other technical network that connects computers to allow communication and data exchange between systems, software applications, and/or users. The computers may be connected via cables, or wirelessly, or both via cables and wirelessly. The server is separated from the client computer. The server could be located remotely from the client computer.

The virtual model could be any digital data type describing geometrical shape. The virtual model may further include texture information. The texture information describes surface textures of the virtual model. The texture information can be any type of visually perceivable data, such as texture, texts, drawings, videos, or their combination. The texture information could a computer-generated image.

In step 4002, the server receives the virtual model. The virtual model may need to be converted to a valid printable virtual model to be used for a 3D printer (step 4003). The converting process may be performed in the server or in the client computer.

In step 4004, the 3D printer prints a real object or a part of the real object according to at least part of the virtual model received by the server or at least part of the valid printable virtual model. The 3D printer is located remotely from the client computer. The real object may be created completely by the 3D printer. It is also possible to create a part of the real object by using the 3D printer, e.g. printing one or more physical objects onto an existing object to build the real object. The existing object could be provided by the user.

In step 4008, the printed real object is delivered to the user, for example by postal service. Separately, an object detection and tracking configuration is generated in step 4005, for example by the server or the client computer, to determine the real object. The object detection and tracking configuration is used to identify the printed real object or a part of the printed real object and/or to determine a pose of the camera with respect to the real object.

For example, the object detection and tracking configuration may be an identification code. The real object is uniquely determined by the identification code within a certain range. For example, the real object may be uniquely determined by the identification code among objects printed by the same 3D printer, or uniquely determined among objects printed by 3D printers according to virtual models received at the same server or sent by the same client/user. The identification code may be any identifying information, such as digital numbers, characters, symbols, binaries, or their combination. The identification code may also be represented by a visual marker (or barcode). The visual marker (or barcode) physically exists and encodes the identification code. The visual marker may also be delivered to the user together with the real object.

The object detection and tracking configuration may be or may be based on a reference image or a virtual model of at least part of real object. The virtual model of the at least part of real object could be sent from the client. A reference image may be captured by a camera or generated from a virtual model of the real object. The real object could be recognized by comparing one or more images captured by the camera of the mobile device with the reference image or with the virtual model.

In step 4006, the computer-generated image is related to the real object, for example by using the object detection and tracking configuration. This could be realized by associating the computer-generated image to the identification code, or to the reference image of the real object, or to the virtual model of the real object, e.g. by generating respective correspondences. The computer-generated image may include the texture information and/or other visually perceivable data for augmenting the real object. The texture information may be the texture information included in the virtual model. Further, the virtual model may also be additionally related to the real object by the identification code.

In steps 4007 to 4012, Augmented Reality (AR) technology is employed to visually enhance or augment the real object by providing AR visualization of overlaying the computer-generated image with the real object. The overlay of the computer-generated image and the real object could be realized by overlaying at least part of the computer-generated image with a 2D view of at least part of the real object. The 2D view of the at least part of the real object is captured by a capturing device, e.g. a camera or a user's eye. For example, the view could be perceived as visual impressions by the user's eye or be acquired as an image by the camera.

The overlaid information of the computer-generated image and the view of the real object can be seen by the users in a well-known optical see-through display attached to the mobile device having semi-transparent glasses. The user then sees through the semi-transparent glasses the real object augmented with the computer-generated image blended in in the glasses. This blends in the at least part of the computer-generated image in the semi-transparent glasses with the view of the at least part of the real object captured by the user's eye.

The overlay of the computer-generated image and the real object can also be seen by the user in a video see-through display attached to the mobile device having a camera and a display device, such as a display screen. The real object is captured by the camera and the overlay is shown in the display to the user. The display could be a monitor, such as a LCD monitor.

The overlay of the computer-generated image and the real object may also be realized by using a projector, for example attached to the mobile device, to project at least part of the computer-generated image onto at least part of the real object. This is often called projector-based AR, or projective AR or spatial AR.

According to the examples of FIGS. 2 and 3, the AR visualization runs on the mobile device equipped with a camera. The mobile device and the client computer may be located at the same device or may be separated devices. The equipped camera could capture an image as the view of the at least part of the real object (step 4009). The mobile device may further have semi-transparent glasses for the optical see-through, or a normal display for the video see-through, or a projector for projecting the computer-generated image. In use, the mobile device is held by the user, mounted to the head of the user, or positioned at a place such that the user could watch the AR visualization.

The object detection and tracking configuration, e.g. the identification code, the reference image of the real object, or the virtual model of the real object, communicates to the mobile device the computer-generated image related to the real object. The computer-generated image or a part of the computer-generated image may be transferred from the server and/or client computer according to the object detection and tracking configuration or generated at the mobile device. The user could manually choose or select at least part of the computer-generated images for the AR visualization.

The mobile device may obtain the object detection and tracking configuration by a manual user input, or by generated locally in the mobile device, or by receiving it from the server, or by downloading it from a cloud (network) of computers. The object detection and tracking configuration may also be associated with a visual marker (or barcode). The camera of the mobile device could capture an image of the visual marker and analyze the marker to obtain the object detection and tracking configuration.

In order to overlay the computer-generated image with the real object at desired positions within the view captured by the eye or the camera, or project the computer-generated image onto desired surfaces of the real object using the projector, a pose of the mobile device with respect to the real object could be computed based on the camera attached to the mobile device and the camera pose with respect to the real object.

Determining a pose of the camera with respect to the real object could be based on an image captured by the camera and the object detection and tracking configuration (step 4010). For determining the camera pose, the virtual model, based on which the real object is printed, could be employed for model based matching. The model based matching could be based on point features or edge features. The edge features are preferred for the pose estimation, as the real object made by the 3D printer is typically textureless and edge features are easier and robustly detectable. This requires the image to contain at least part of the real object described by the virtual model. It is also possible to use a visual marker to determine the camera pose. This requires the visual marker to have a known size and fixed rigidly relative to the real object. In this case, the camera pose could be determined according to a camera pose with respect to the visual marker from an image of the camera containing the visual marker. The visual marker may encode the identification code in order to recognize the real object. The camera pose with respect to real object could also be determined based on the reference image.

When the view is captured as an image by the camera, the captured image may be also used to determine a camera pose of the image with respect to the real object, i.e. the pose of the view with respect to the real object.

When the view is captured by the eye, in addition to determining the camera pose, it further needs a spatial relationship between the eyes and the camera for determining the pose of the view of the eye relative to the real object. This may be realized by an eye orientation detection system and a known location of the eye orientation detection system relative to the camera.

For using the projector to project the computer-generated image onto the real object, in addition to determining the camera pose, it further needs a spatial relationship between the projector and the camera for determining a pose of the projector relative to the real object.

An RGB-D camera system is a capturing device that could capture an RGB-D image of a real environment or a part of a real environment. An RGB-D image is an RGB image with a corresponding depth map. The present invention is not restricted to capture systems providing color images in the RGB format. It can also be applied to any other color format and also to monochrome images for example to cameras providing images in grayscale format.

Projecting the computer-generated image on surfaces of the real object using a projector could also be implemented by estimating a spatial transformation between a RGB-D camera system and the real object based on a known 3D model of the real object. A spatial transformation between the projector and the real object could be estimated based on one or more visual patterns projected from the projector onto the real object and a depth map of the projected visual patterns captured by the RGB-D camera system.

A spatial transformation between the projector and the RGB-D camera as well as the intrinsic parameters of the projector could be computed based on the 2D coordinates of the visual patterns in the projector coordinate system and corresponding 3D coordinates of the visual patterns in the RGB-D camera coordinate system. Finally, the spatial transformation between the projector and the real object is computed based on the estimated spatial transformation between the real object and the RGB-D camera system and the estimated spatial transformation between the projector and the RGB-D camera system.

Furthermore, the present invention does not require the projector and the RGB-D camera system to be rigidly coupled or a pre-known spatial transformation between the projector and the RGB-D camera system. This increases the usability and flexibility of the present invention compared to the prior arts.

Although this invention has been shown and described with respect to the detailed embodiments thereof, it will be understood by those skilled in the art that various changes in form and detail may be made without departing from the spirit and scope of the invention.

What is claimed is:

1. A method for visually augmenting a real object with a computer-generated image comprising:
sending a virtual model in a client-server architecture from a client computer to a server via a computer network;
receiving the virtual model at the server;
instructing a 3D printer to print the real object or a part of the real object according to at least part of the virtual model received at the server;
generating an object detection and tracking configuration configured to identify the real object or a part of the real object;
receiving an image captured by a camera representing at least part of an environment in which the real object is placed;
determining a pose of the camera with respect to the real object according to the object detection and tracking configuration and at least part of the image; and
overlaying at least part of a computer-generated image with at least part of the real object according to the object detection and tracking configuration and the pose of the camera.

2. The method according to claim 1, wherein the object detection and tracking configuration is or contains an identification code.

3. The method according to claim 2, wherein the object detection and tracking configuration is based on at least one of: a reference image of at least part of the real object and a virtual model of at least part of the real object.

4. The method according to claim 1, further comprising determining the pose of the camera with respect to the real object based on an image captured by the camera and a visual marker fixed relative to the real object.

5. The method according to claim 4, wherein the visual marker encodes an identification code.

6. The method according to claim 1, further comprising determining the pose of the camera with respect to the real object based on an image captured by the camera and a virtual model of at least part of the real object.

7. The method according to claim 6, wherein edge features are used to determine the pose of the camera.

8. The method according to claim 1, wherein the camera is part of or associated with a mobile device.

9. The method according to claim 8, wherein the mobile device is the client computer.

10. The method according to claim 8, further comprising the mobile device obtaining the object detection and tracking configuration by a manual user input, or by receiving it from the server, or by downloading it from a cloud of computers.

11. The method according to claim 8, wherein the mobile device comprises a display adapted to display an image captured by the camera, and the step of overlaying at least part of the computer-generated image with at least part of the real object comprises overlaying the at least part of the computer-generated image with an image of the at least part of the real object captured by the camera and displayed on the display of the mobile device.

12. The method according to claim 8, wherein the mobile device comprises semi-transparent glasses, and the step of overlaying at least part of the computer-generated image with at least part of the real object comprises blending in the at least part of the computer-generated image in the semi-transparent glasses with a view of the least part of the real object captured by a user's eye.

13. The method according to claim 12, wherein the camera has a known position relative to the user's eye.

14. The method according to claim 1, further comprising a projector, and the step of overlaying at least part of the computer-generated image with at least part of the real object comprises projecting the at least part of computer-generated image onto the at least part of the real object by the projector.

15. The method according to claim 13, wherein the camera has a known position relative to the projector.

16. A computer program product comprising a computer readable storage medium having computer readable software code sections embodied in the medium, which software code sections are configured to perform a method according to claim 1.

17. A system for visually augmenting a real object with a computer-generated image, comprising:
a client computer in communication with a server via a computer network;
a 3D printer; and
a camera;
wherein the client computer is adapted to selectively send a virtual model in a client-server architecture to the server via the computer network, and the server is adapted to receive the virtual model; and
wherein the server is adapted to instruct the 3D printer to print the real object or a part of the real object according to at least part of the virtual model received at the server; and
wherein one of the client computer or the server is adapted to generate an object detection and tracking configuration configured to identify the real object or a part of the real object; and
wherein one of the client computer or server is adapted to receive an image captured by the camera, which image represents at least part of an environment in which the real object is placed, and to determine a pose of the camera with respect to the real object according to the object detection and tracking configuration and at least part of the image, and to overlay at least part of the computer-generated image with at least part of the real object according to the object detection and tracking configuration and the pose of the camera.
